(19) United States
(12) Patent Application Publication
(10) Pub. No.: US 2020/0112712 A1
(43) Pub. Date: Apr. 9, 2020

(54) Placement And Dynamic Rendering Of Caption Information In Virtual Reality Video

(71) Applicant: Within Unlimited, Inc., Los Angeles, CA (US)

(72) Inventors: Aaron Koblin, Venice, CA (US); Chris Milk, Los Angeles, CA (US)

(21) Appl. No.: 16/679,068

(22) Filed: Nov. 8, 2019

Related U.S. Application Data
(63) Continuation of application No. PCT/IB2018/052863, filed on Apr. 25, 2018.
(60) Provisional application No. 62/504,030, filed on May 10, 2017.

(51) Int. Cl. H04N 13/183; H04N 13/194; H04N 13/161; H04N 21/488; H04N 13/178; H04N 19/597

(52) U.S. Cl. CPC H04N 13/183; H04N 13/194; H04N 19/597; H04N 21/4884; H04N 13/178; H04N 13/161

(57) ABSTRACT

A method of adding caption information to a multi-view three-dimensional (3D) video, wherein the video has a duration, and wherein, at a given time in the duration of the video, a user may view multiple distinct scenes of the video. The method includes (A) associating multiple distinct viewing directions or regions with the multi-view three-dimensional video; and (B) at a particular time in the duration of the video, associating one or more first captions with a first direction or region of the multiple distinct viewing directions or regions, and associating one or more second captions with a second direction or region of the multiple distinct viewing directions or regions, said first direction or region being distinct from the second direction or region.

### CROSS-REFERENCE TO RELATED APPLICATIONS

This application is a continuation of PCT/IB2018/052863, filed Apr. 25, 2018, which claims the benefit of U.S. Provisional Application No. 62/504,030, filed May 10, 2017, the entire contents of both of which are hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to virtual reality (VR), 360-Degree video, and augmented reality (AR), and, more particularly, to captioning in VR, AR, and 360-Degree videos.

### BACKGROUND

Two- and three-dimensional (3D) video display devices are ubiquitous. Movies and television have used two-dimensional (2D) displays (e.g., TV or movie screens or the like) since their inception. Three-dimensional video renderings are typically produced using a single video display that produces two images, one for each eye. 3D videos may be captured, e.g., using two side-by-side lenses. The images captured by each lens may be separately viewed by a user using specialized glasses (e.g., that filter the different images for each eye or that use polarized light).

Captions (e.g., subtitles, closed captions, etc.) have been provided with 2D and 3D displays. Captions are generally added to video content as part of post-production editing. Since 2D video displays are essentially “flat,” in 2D the decisions to be made about captions are their style (e.g., font size, color, rendering options, etc.) and location (i.e., where they should be placed) in a 2D plane.

With both 2D and 3D video, captions are rendered at preset locations based on time. However, providing captions for three-dimensional content is much more complicated than for two-dimensional content. This is because there are many more variables that have to be controlled and taken into account. Unlike 2D video captions, with 3D video content, at least the depth of a caption in the image should also be taken into account. That is, with 3D content, a caption's placement should account for perceptual depth placement.

Virtual reality (VR), so-called “360 video,” AR, and real-time rendering (RTR), add complexity to placement and rendering of captions. It is desirable and an object of this invention to provide methods, systems, and devices for placement and rendering of captions in VR, AR, and “360 video.”

### SUMMARY

The present invention is specified in the claims as well as in the below description. Preferred embodiments are particularly specified in the dependent claims and the description of various embodiments.

A skilled reader will understand, that any method described above or below and/or claimed and described as a sequence of steps or acts is not restrictive in the sense of the order of steps or acts.

Below is a list of method or process embodiments. Those will be indicated with a letter “M”. Whenever such embodiments are referred to, this will be done by referring to “M” embodiments.
M1. A method of adding caption information to a multi-view three-dimensional video, wherein the video has a duration, and wherein, at a given time in the duration of the video, a user may view multiple distinct scenes of the video, the method comprising:
(A) associating multiple distinct viewing directions or regions with the multi-view three-dimensional video;
(B) at a particular time in the duration of the video, associating one or more first captions with a first direction or region of said multiple distinct viewing directions or regions, and associating one or more second captions with a second direction or region of said multiple distinct viewing directions or regions, said first direction or region being distinct from said second direction or region.
M2. The method of embodiment M1 further comprising: repeating act (B) for multiple distinct particular times.
M3. The method of embodiments M1 or M2 wherein said associating in (A) associates at least M12 multiple distinct viewing directions or regions with the video.
M4. The method of embodiments M1-M3 wherein the multiple distinct viewing regions are non-overlapping.
M5. The method of embodiments M1-M4 wherein said associating in (B) associates multiple captions with said video, the method further comprising: (C) forming a second video from said multiple captions.
M6. The method of embodiment M5 wherein said second video has a lower resolution than said multi-view three-dimensional video.
M7. The method of embodiments M1-M6 wherein at least one of said captions associated with said multi-view three-dimensional video is positioned at a depth location within said video.
M8. A method comprising:
(A) displaying a multi-view three-dimensional video to a user, wherein scenes from the video are displayed to the user based on the direction the user is viewing, and wherein at least one particular time in the video has multiple captions associated with the video at the particular time; and
(B) at said at least one particular time in said video, displaying at least one caption to the user, wherein the at least one caption of said multiple captions is displayed to the user based on the direction the user is viewing at the particular time.
M9. The method of embodiment M8 wherein the at least one caption is displayed in real time to the user.
M10. The method of embodiments M8 or M9 wherein, in response to the user changing their viewing orientation, displaying a second at least one caption to the user.
M11. The method of any one of embodiments M8 to M10 wherein, in response to the user changing their viewing orientation, displaying said least one caption to the user based on the speed at which the user changes their viewing orientation.
M12. A method comprising:
(A) obtaining a first video comprising a multi-view three-dimensional video;
(B) obtaining a second video comprising multi-view three-dimensional captions associated with said first video; and
(C) rendering said first video in combination with said second video.

Below is a list of article of manufacture embodiments. Those will be indicated with a letter “A”. Whenever such embodiments are referred to, this will be done by referring to “A” embodiments.
A13. An article of manufacture comprising a computer-readable medium having program instructions stored thereon, the program instructions, operable on a computer system, wherein execution of the program instructions by one or more processors of said computer system causes the one or more processors to carry out the acts of:
(A) associating multiple distinct viewing directions or regions with the multi-view three-dimensional video;
(B) at a particular time in the duration of the video, associating one or more first captions with a first direction or region of said multiple distinct viewing directions or regions, and associating one or more second captions with a second direction or region of said multiple distinct viewing directions or regions, said first direction or region being distinct from said second direction or region.
A14. The article of manufacture of embodiment A13 wherein execution of the program instructions by one or more processors of said computer system causes the one or more processors to carry out the acts of: repeating act (B) for multiple distinct particular times.
A15. The article of manufacture of embodiments A13 or A14 wherein said associating in (A) associates at least M12 multiple distinct viewing directions or regions with the video.
A16. The article of manufacture of any one of embodiments A13-A15 wherein the multiple distinct viewing regions are non-overlapping.
A17. The article of manufacture of any one of embodiments A13-A16 wherein said associating in (B) associates multiple captions with said video, the acts further comprising: (C) forming a second video from said multiple captions.
A18. The article of manufacture of embodiment A17, wherein said second video has a lower resolution than said multi-view three-dimensional video.
A19. The article of manufacture of embodiments A13-A18, wherein at least one of said captions associated with said multi-view three-dimensional video is positioned at a depth location within said video.

Below is a device embodiment, indicated with a letter “D”.
D20. A device constructed and adapted to perform any of the methods of embodiments M1-M12.

The above features along with additional details of the invention, are described further in the examples herein, which are intended to further illustrate the invention but are not intended to limit its scope in any way.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 describes aspects of captions according to exemplary embodiments hereof;

FIG. 2 describes aspects of VR video according to exemplary embodiments hereof;

FIG. 3 shows aspects of VR video according to exemplary embodiments hereof;

FIGS. 4-5 and 6A-6G describe aspects of captioning VR content according to exemplary embodiments hereof;

FIG. 7 depicts aspects of a viewing/rendering device according to exemplary embodiments hereof;

FIGS. 8A-8C are flowcharts showing aspects of exemplary functionality of a viewing application for VR video according to exemplary embodiments hereof;

FIG. 9 depicts a flowchart showing aspects of video production according to exemplary embodiments hereof;

FIG. 10 depicts aspects of a computer system for implementing aspects of video production according to exemplary embodiments hereof;

FIG. 11 is a flowchart depicting aspects of a captioning application according to exemplary embodiments hereof;

FIGS. 12A-12C show an exemplary way to partition a virtual viewing space according to exemplary embodiments hereof;

FIG. 13 depicts aspects of a data structure to maintain and store caption information according to exemplary embodiments hereof;

FIGS. 14A-14C and 15 show an example of captions created using the caption editing application according to exemplary embodiments hereof;

FIGS. 16A-16B depicts aspects of captioning according to exemplary embodiments hereof; and

FIG. 17 is a block diagram depicting aspects of a computer system.

### DETAILED DESCRIPTION OF THE PRESENTLY PREFERRED EXEMPLARY EMBODIMENTS

Glossary and Abbreviations

As used herein, unless used otherwise, the following terms or abbreviations have the following meanings:

“2D” or “2-D” means two-dimensional;

“3D” or “3-D” means three-dimensional;

“AR” means augmented reality;

“HMD” means head-mounted display;

“RTR” means real-time rendering;

“VR” means virtual reality.

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### DESCRIPTION

In the following, exemplary embodiments of the invention will be described, referring to the figures. These examples are provided to provide further understanding of the invention, without limiting its scope.

In the following description, a series of features and/or steps or acts are described. The skilled person will appreciate that unless required by the context, the order of features and steps or acts is not critical for the resulting configuration and its effect. Further, it will be apparent to the skilled person that irrespective of the order of features and steps or acts, the presence or absence of time delay between steps or acts, can be present between some or all of the described steps or acts.

It will be appreciated that variations to the foregoing embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

### Overview

Captions

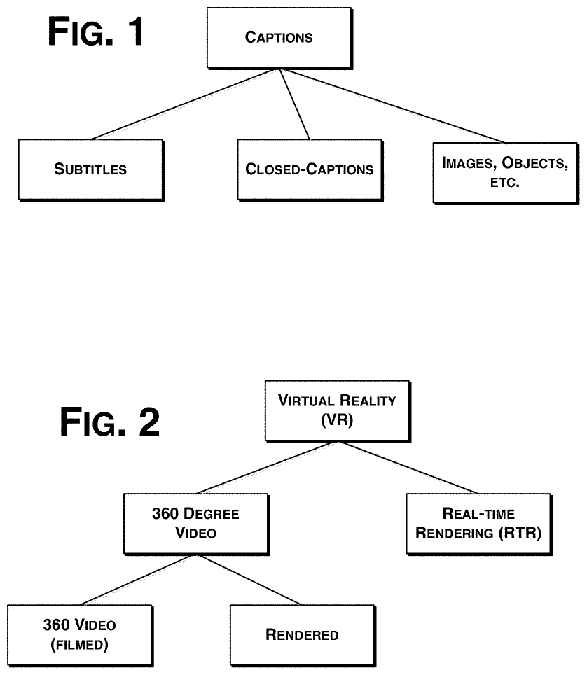

As used herein, the term “caption” generally refers to any content (e.g., textual and/or graphical information) provided at one or more locations in a video display. A caption may be a subtitle, a closed caption, a label, an icon, or some other information. Subtitles are mainly intended for users who can hear and generally display only something spoken by a character. Subtitles often provide language translation. The term “closed captions” generally refers to subtitles for all sound (e.g., diegetic sound) in a video, not only speech. With reference to FIG. 1, captions may include sub-titles, closed captions, images, objects, and/or combinations thereof. Thus, as used herein, the term “caption” is broadly construed to refer to anything, including content, that may be displayed or somehow rendered on a display device. A caption is not limited to textual information or to images or icons corresponding to the audio track of a video. The scope of the invention is not limited by the content of any caption.

VR

A 360-degree video (sometimes referred to as a “360 video,” and also known as an immersive or spherical video) is a video recording in which views in multiple directions are recorded at the same time. A 360-degree video comprises actual photographic images from an omnidirectional camera or a collection of multiple cameras. The images from the various cameras are joined or stitched together when captured and/or when rendered, to appear as a seamless whole during playback. While a 360-degree video may not actually record a view in every direction at the same time, the rendering process is generally able to form or create a view in every direction when the video is viewed.

A 360-degree video rendering may be 3D, depending on how captured and viewed. For example, 360-degree videos may be viewed via personal computers (PCs), and on mobile devices such as smartphones, in which case the rendering may be 2D. When viewed using a head-mounted display (or HMD), a 360-degree video is preferably 3D, meaning that it is rendered and viewed as two distinct images (e.g., two distinct equirectangular images), one directed to each of the viewer's eyes.

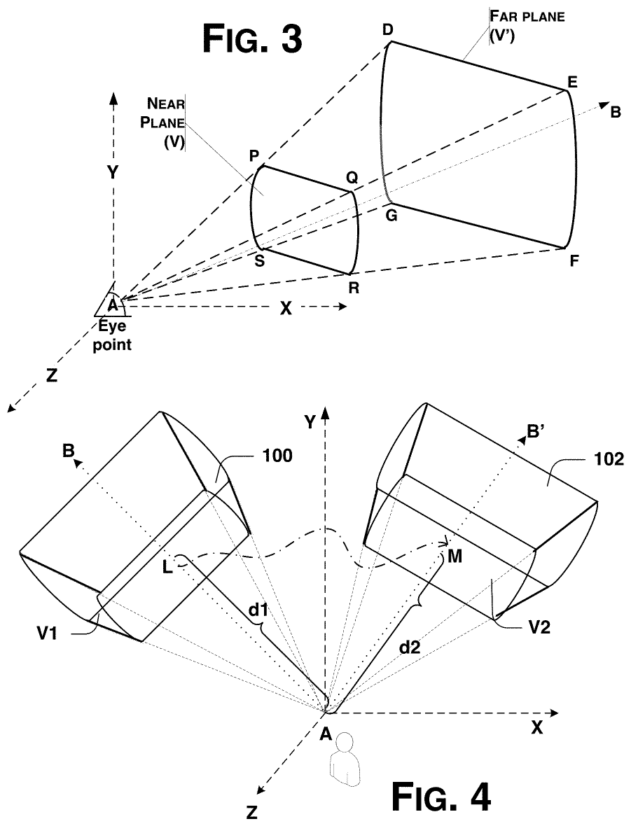

As used herein, for the purposes of this description, the term virtual reality (VR) generally encompasses content that may be at least partially artificial (e.g., computer generated), including AR. VR video may be a 360-degree video and/or rendered, and also encompasses real-time rendered (RTR) content. Thus, as shown in FIG. 2, the term VR is broadly construed to cover 360-degree video (filmed and/or rendered), and real-time rendered content. These terms are used here for convenience and shorthand, and not to limit the scope of the invention in any way.

The term “video” or “video content” refers to any content that may be rendered on a video display device, regardless of how that content was generated or formed. Video content may include filmed content, computer generated content, real-time rendered content, and/or combinations thereof. Unless specifically stated herein, the term VR video refers to any VR video content, no matter how that video content is produced and/or generated. The scope of the invention is not limited by the kind of video or video content or by the manner in which it is produced or generated.

Viewing a VR Video

Various dedicated HMD devices are available, including devices from Google and Oculus. During playback, a viewer has control of the viewing direction, and a 360-degree video may be panned or viewed on a wearable HMD device based on the movement and/or orientation of the user's head. To this end, HMD devices may include sensors (e.g., one or more gyroscopes, one or more accelerometers, etc.) in order to determine the orientation and/or speed of movement of the device. Some devices (e.g., Oculus Rift and HTC's Vive) may use external sensors for position tracking. Some devices (e.g., Google Cardboard and Samsung Gear VR) provide enclosures for smartphones (e.g., Apple's iPhone or Android phones or the like). These enclosure-based devices hold a user's smartphone in place and emulate operation of a dedicated HMD, while using the display and sensors (e.g., one or more gyroscopes, one or more accelerometers, magnetometers, etc.) of the enclosed phone.

Preferably a VR viewing device (e.g., an HMD, or the like) can determine the relative movements of the viewer in the VR space, including information such as the velocity of such movements. Thus, preferably a VR viewing device such as an HMD can determine not just where the viewer is looking in the VR space, but also the viewer's relative movements in that space.

A video or movie consists of set of frame information with corresponding time information. The frames are rendered in order at the corresponding times (typically relative to a start time). For a 3D video (e.g., a 360 video) to be viewed using two rectangular images, the frame information comprises sufficient information to render the two rectangular images. The viewer of a VR video (e.g., a 360 video) is generally considered to be at the origin of a 3D space, and the rendering of a VR video is based on the direction the viewer is looking within that 3D space. The 3D space of a VR video may be referred to herein as the VR space.

With reference to FIG. 3, a viewer at location A in a 3D space is looking in the direction AB, where B is some arbitrary point in the 3D space. Without loss of generality, the point A may be considered to be the origin (0, 0, 0) of the 3D space.

The user's location (at point A) and viewing direction (along and in the direction of line AB) define the user's view which may be considered to be a 3D region 100 around the line AB, as shown in the drawing in FIG. 3. Although the user can view anything within their viewing direction (in this case the direction AB), actual video content of interest may be the 3D region (defined by the viewing direction (AB) and two planes denoted V and in the drawing). The first plane (V, defined by the points PQRS) is sometimes referred to as a near plane, and the second plane (V, defined by the points DEFG) is sometimes referred to as a far plane. This 3D region is generally frustum shaped and defined by the points PQRS and DEFG. As shown in the drawing, the sides (PS, QR, DG, and EF) of the planes are generally curved or bow shaped.

This 3D region is sometimes referred to here as a region of interest and essentially provides the bounds of the VR world that the viewer sees when looking from point A in a direction along the virtual line AB.

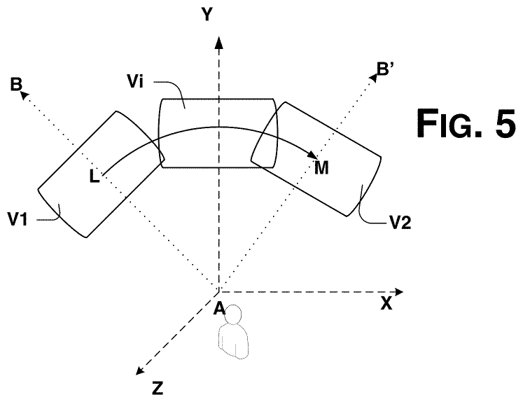

A user viewing a VR video may change their viewing region, e.g., by some form of movement (e.g., head movement and/or body movement or the like). As discussed above, the VR video viewing device (e.g., an HMD or the like) can determine the user's movements and change the user's viewing region accordingly, as needed. For example, as shown in FIG. 4, a user changes their viewing region from a 3D viewing region 100 associated with viewing direction AB to a different viewing region 102 associated with viewing direction AB′. This change of viewing direction may have occurred, e.g., when the user rotated their head and/or body along the path LM. As should be appreciated, the path LM may be an arbitrary path from the first viewing region 100 (associated with viewing direction AB) to the second viewing region 102 (associated with viewing direction AB′). Note too, that the viewing regions 100 and 102 may overlap or be completely distinct.

A user viewing VR may be considered to be viewing the VR content via a virtual camera. By moving and/or rotating their head/body, the user thus effectively changes the virtual camera's position and/or orientation.

As should be appreciated, the preferred viewing region within a viewing frustum may not be at the same distance from the viewer for each viewing direction. Thus, e.g., in the drawing in FIG. 4, the viewing region 100 need not be at the same distance from the user as the viewing region 102 (i.e., the distance d1 need not be the same as the distance d2). As should be appreciated, a viewer's distance from a viewing region spans their distance to the near plane to their distance to the far plan. However, for the sake of this description, unless otherwise stated, the user's distance from the viewing region refers to their distance from the near plane.

With reference now to FIG. 5, when the user changes their viewing direction from direction AB (with viewing region V1) to direction AB′ (corresponding to viewing region V2) along some arbitrary path LM, their viewing region or region of interest essentially moves along that path from viewing region V1 to viewing region V2 via intermediate viewing regions (denoted Vi in the drawing). For convenience, the path LM is shown in the drawing as an arc, although it may be any arbitrary path. Although only one intermediate region Vi is shown in the drawing, it should be appreciated that the user's movement from viewing direction AB to viewing direction AB′ along the path LM is likely continuous, with a series of corresponding intermediate overlapping viewing regions (Vi).

Although a viewing region generally comprises a 3D volume (e.g., frustum) bounded by two planes, as shown in FIGS. 3-4, in FIG. 5 and subsequent figures, the region is shown as 2D a rectangle with two arced sides.

As should be appreciated, the content in a particular viewing region does not move when the user moves, rather the user's view moves (akin, e.g., to the user turning their head or body or the like).

### DESCRIPTION

Captions in VR

In order to render a caption within a VR video (360-degree, RTR, or otherwise), the following information is required:
The content to be rendered (e.g., the text, graphic, etc.);
The location of the content in the VR space (preferably in VR space coordinates, with the viewer's location treated as the origin); and
The time period during which the content is to be rendered.

At any given time there may be multiple captions associated with a video, with different captions at different locations (e.g., (x, y, z) positions/coordinates in the VR space). There may be multiple captions associated with a particular VR location.

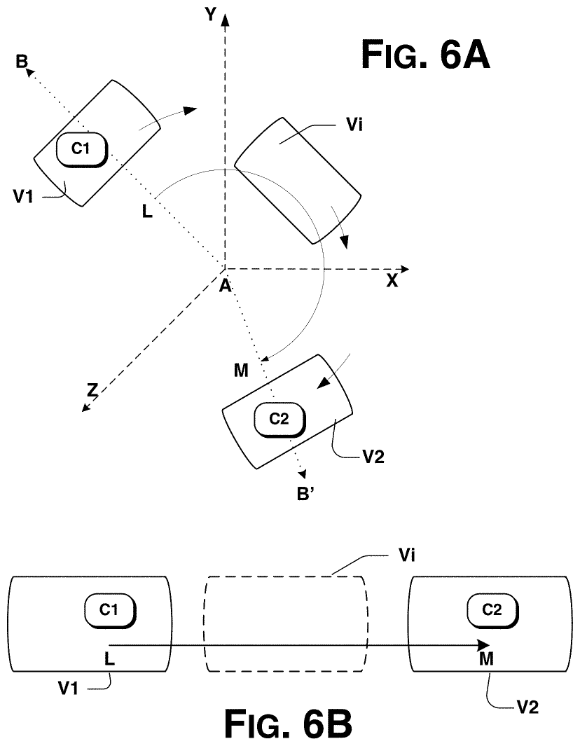

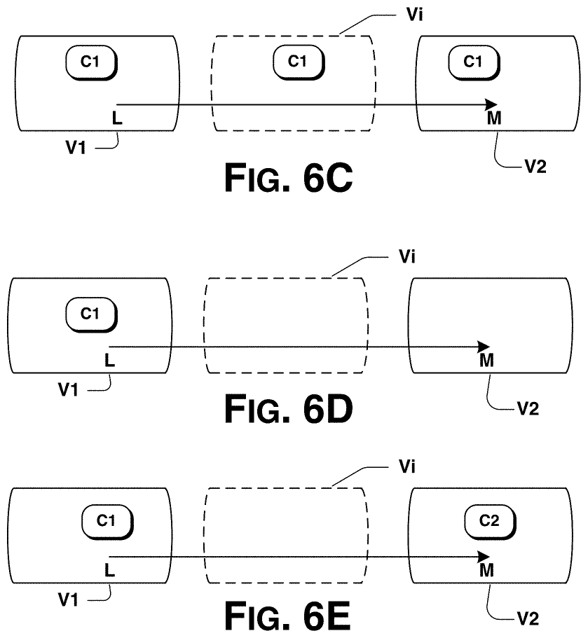

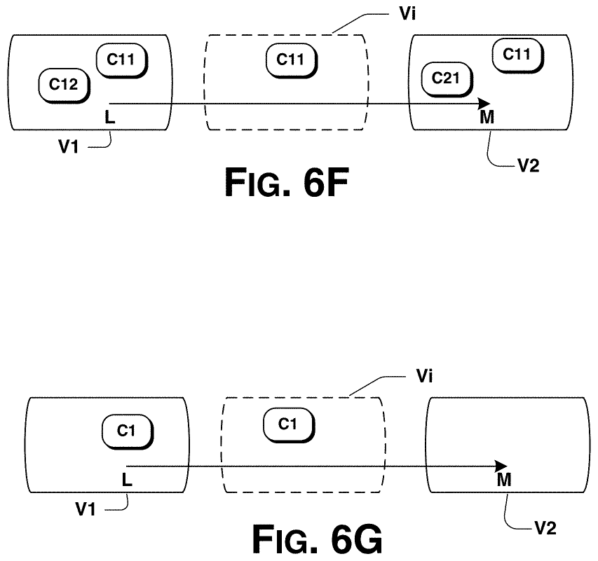

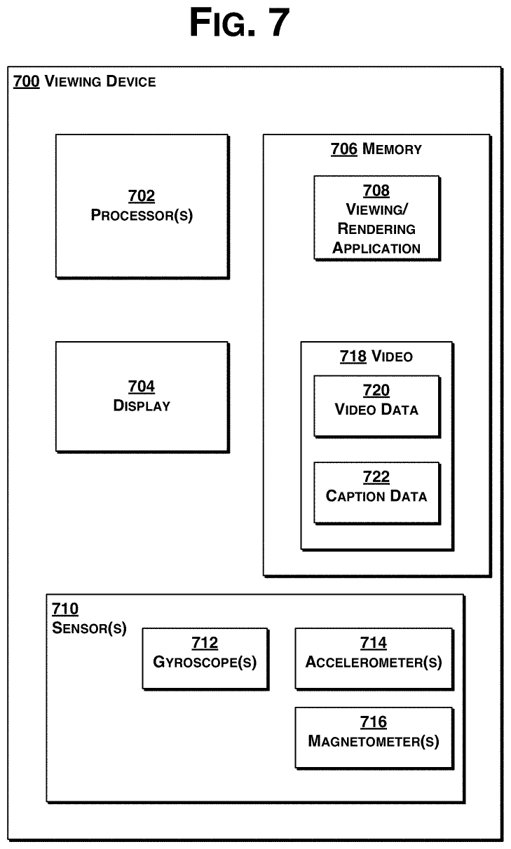

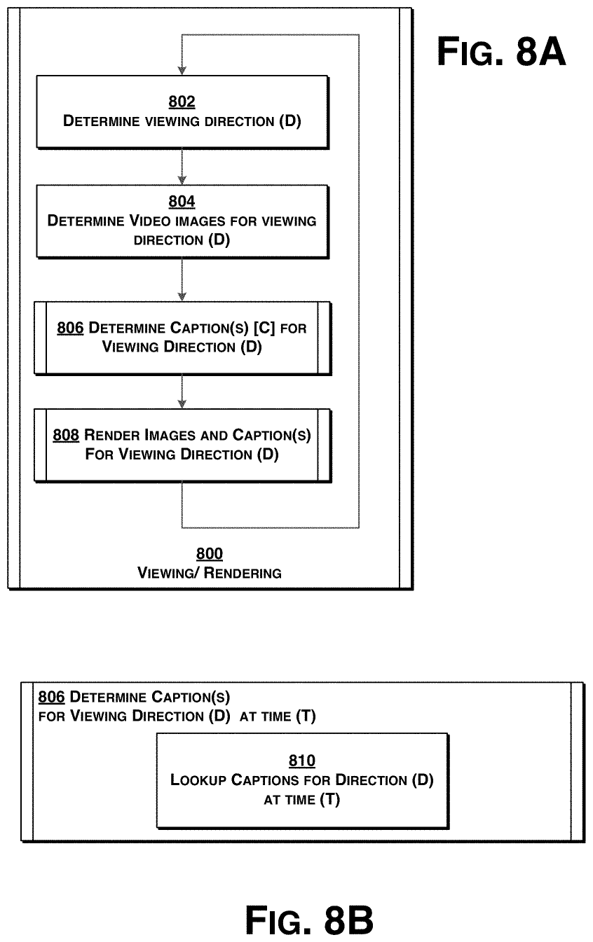

The user's display should present all captions that are in the user's view. When a particular caption is in a user's view, that caption is said to be associated with that view. Thus, with reference to the example VR space shown in FIG. 6A, when the viewer at position A in the VR space is looking in the direction AB, captions C1 in the user's view V1 in the VR video should be presented in the user's display. When the user changes their viewing direction to correspond to the direction AB′ (e.g., by movement, rotation, or the like), captions C2 in their new view V2 should be presented. It should be appreciated that the user's movement and the corresponding presentation of the video and captions are essentially continuous. Thus, a caption at a particular location will preferably be visible to the user when the caption's location is within the frustum that defines the user's view. Preferably the caption will be visible even if it is at the edge of the frustum, even partially inside of the frustum.

Thus, with reference to FIG. 6A, assume that captions C1 are associated with the viewing region V1 (along viewing direction line AB), and that captions C2 are associated with the viewing region V2 (along viewing direction line AB′), then the captions C1 should be displayed when the user is looking in the viewing region VI along the viewing direction line AB, and the captions C2 (in the viewing regions V2) should be displayed when the user is looking along the viewing direction line AB′. Although the captions are shown at two locations in the drawing, those of ordinary skill in the art will appreciate and understand, upon reading this description, that a particular caption may be visible to the user for all viewing direction lines that intersect a viewing region that contains at least a part of the particular caption. Therefore, e.g., the captions C1 should be visible to the user at A for all viewing regions Vj that contain some or all of C1. Note that the captions C1 and C2 may be distinct or the same. Note too that C1 and C2 may refer to multiple captions that should be rendered in their respective viewing regions.

Preferably the captions in a particular viewing region are rendered at a VR distance from the viewer between the near plane and the far plane for that viewing region. If there are multiple captions within a viewing region, they need not all be rendered at the same virtual distance from the user in the VR space.

In the drawings in FIGS. 6B-6G the viewing regions are shown, for simplicity, as rectangles with bowed sides, from the direction of the viewer. That is, in FIGS. 6B-6G the viewer is looking directly into the regions.

Movement of a user's viewing direction along an arbitrary path (e.g., path LM) may be referred to here as a transition, and the path may sometimes be referred to as a transition path.

From the user's perspective, as shown in FIG. 6B, as their view changes along the transition path LM, the captions C1 appear in the start view V1, and the captions C2 appear in the view V2. Although only one intermediate view Vi is shown in FIG. 6B, it should be understood that the system preferably presents the viewer with a continuous stream of views, making the transition from view V1 to view V2 smooth. The system provides various options (described below) for captioning in the intermediate views during movement associated with the transition. Ways to deal with captions during movement include:
Static transition
Immediate caption movement
Delayed caption movement
No caption during movement

The various options are not necessarily mutually exclusive, and different and/or other movement and transition options may be used.

With immediate caption movement, as shown in FIG. 6C, the captions C1 are present in all intermediate views and appear to move with and essentially at the same rate as the intermediate views.

With delayed caption movement, the captions move at a different (e.g., slower) speed than the intermediate views, so that the captions may appear to drift into the second view (V2 in FIG. 6D). Thus, with reference to FIGS. 6D and 6E, when the user's viewing direction transitions along path LM from view V1 to view V2, first the user sees view V2, and then, after some delay, the captions C2 appear in view V2 (as shown in FIG. 6E). The delay may be only a few seconds. The captions C2 may appear in view V2 by floating or drifting into the view, preferably from the same direction that the view changed (LM in FIG. 6E), and preferably along the transition path LM.

The immediate movement option effectively gives the caption the same transition speed along path LM as the VR video. The delayed caption movement, in some cases, effectively gives the caption a reduced transition speed (e.g., 90% or 95% or some other value) relative to the VR video along the transition path. This approach may give the appearance of the caption catching up to the video in movement.

The transition and/or movement of the captions may be a function of the movement of the user (e.g., the user's speed, direction, acceleration, etc.) For example, if the user makes a quick and jerky movement, then an immediate caption movement may be preferred.

As noted above, there may be multiple captions associated with a particular viewing direction. Thus, e.g., the captions denoted C1 and C2 in the drawings may correspond to more than one individual caption. Different individual captions or groups of captions may have different transitions during movement.

For example, as shown in FIG. 6F, in the view V1, captions C11 and C12 are visible. As the user transitions along the path LM to view V2, the captions C11 remain in view (along the path), whereas the captions C21 (corresponding to captions C12) only appear in the view V2 and not along the transition path.

In another example, as shown in FIG. 6G, captions C1 are visible in view V1 and along the path, but are not visible in the view V2. This may be because the captions C1 are no longer appropriate (given the time in the video) or because captions C1 were set to not be visible in the view V2. A trivial example of this case is where the captions C1 describe the viewing direction relative to some framework (e.g., “Front”, and “Back”). If the point of view V1 is forward then the caption C1 will be “Front,” but if the point of view is to the side (i.e., V2 is a sideways view relative to the framework), then there may be no captions to display for that view.

The captions and transitions described here are only exemplary, and are not intended to limit the scope of the invention in any way.

The transition(s) associated with caption(s) may be set as per caption policies, with default system policies in effect. For example, the default transition policy for captions for a system may be “Immediate caption movement,” which can be overridden on a caption-by-caption basis.

The policies may be configurable based on the user's movements and their speeds. For example, the default transition policy may be “Immediate caption movement,” for user speeds below a predetermined speed, and “Delayed caption movement” for speeds above that predetermined speed.

Those of ordinary skill in the art will appreciate, upon reading this description, that the predetermined speeds may be chosen to provide a desired visual effect.

Rendering VR Video with Captions

A VR video with associated caption information (e.g., as described above) may be rendered and viewed on viewing device, e.g., device 700 shown in FIG. 7 including a processor 702, display 704, and memory 706. A viewing/rendering application or mechanism 708 in memory 706 supports the functionality of rendering the video for viewing. The viewing device 700 may be or comprise a dedicated HMD device or a smartphone in combination with an enclosure (e.g., the Google Cardboard or Samsung Gear VR). The viewing device 700 preferably includes one or more sensors 710 (e.g., one or more gyroscopes 712, one or more accelerometers 714, magnetometers 716, etc.) in order to determine the orientation and/or speed of movement of the device. External sensors may be used instead (or as well) to determine the orientation and/or speed of movement of the device. When the viewing device 700 is a smartphone, the sensors in the phone may be used. As should be appreciated, the viewing device 700 is a computer system (as discussed below in the section titled “Computing”).

The video 718 to be viewed may be streamed to the device or, preferably, stored in a memory (e.g., memory 706) of the device 700. The video 718 preferably includes video data (e.g., video data 720) and the caption information (e.g., caption data 722).

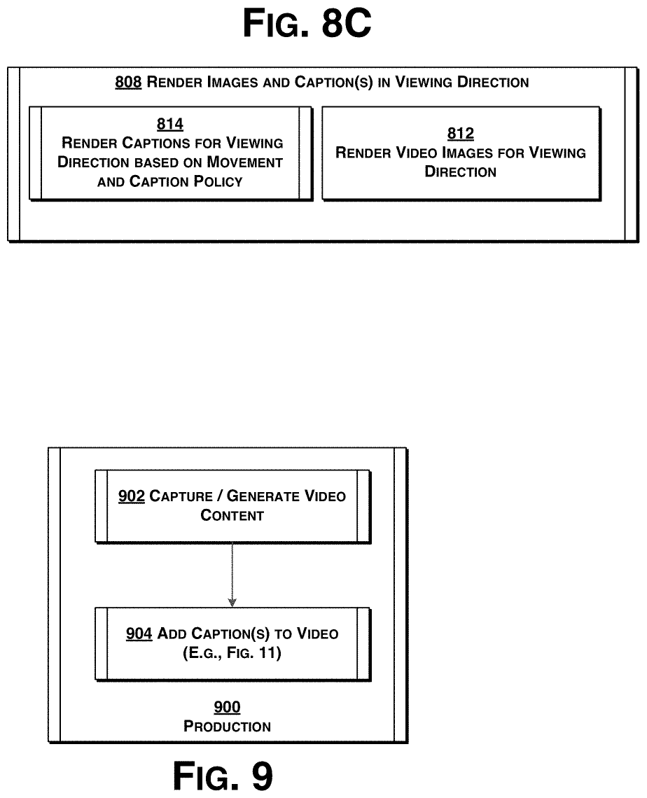

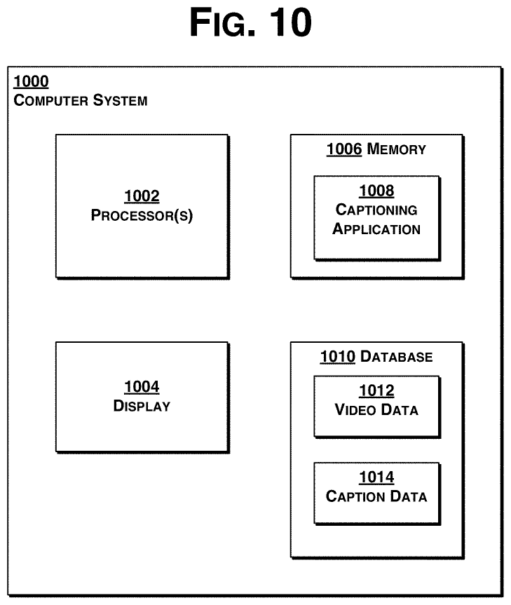

FIG. 8A is a flowchart showing exemplary functionality of the viewing application 708 for a VR video with captions. As shown in FIG. 8A, the viewing application 708 determines the user's viewing direction (at 802). As noted above, the viewer/user may initially be assumed to be at the origin or some point of a 3D space, and the rendering of a VR video is based on the direction the viewer is looking within that 3D space. Without loss of generality, when the video starts the user is generally shown the front view. Any movement (including a change in orientation) by the user after the video starts (at time T0) is relative to the front direction. One or more sensors in the viewing device 700 (e.g., one or more gyroscopes) and/or one or more external sensors may be used to determine the user's current viewing direction (at 802).

The viewing application 708 then determines (at 804) the video images in the video 712 corresponding to the current viewing direction (D), and determines (at 806) the caption(s) (if any) for the current viewing direction (D). The application then renders the images and caption(s) (at 808) for the current viewing direction (D). The process is repeated until the video ends or the viewing is otherwise ended by the user.

As shown in FIG. 8B, determining the caption(s) for viewing direction D at time T may comprise determining (e.g., looking up) (at 810) the caption information for direction D at time T.

The act of rendering images and caption(s) (at 808) for the current viewing direction may take into account the user's current movements in order to handle caption transitions, as describe above. For example, as shown in FIG. 8C, the video for the viewing direction is rendered (at 812), while, in parallel, the caption(s) for the field of view are rendered (at 814) based on the movement of the view (e.g., speed of movement, rotation, etc.) and on caption transition and rendering policies associated with the caption(s). As should be appreciated, the images and caption(s) may be rendered (at 808) as a single rendered image.

Thus, when the user looks in a particular direction, the rendering mechanism renders the caption(s) associated with that direction. When the user changes their viewing direction to a new region/location (as determined by the sensors in the viewing device and/or phone), then the rendering mechanism renders the caption(s) associated with that new region/location.

Video Production

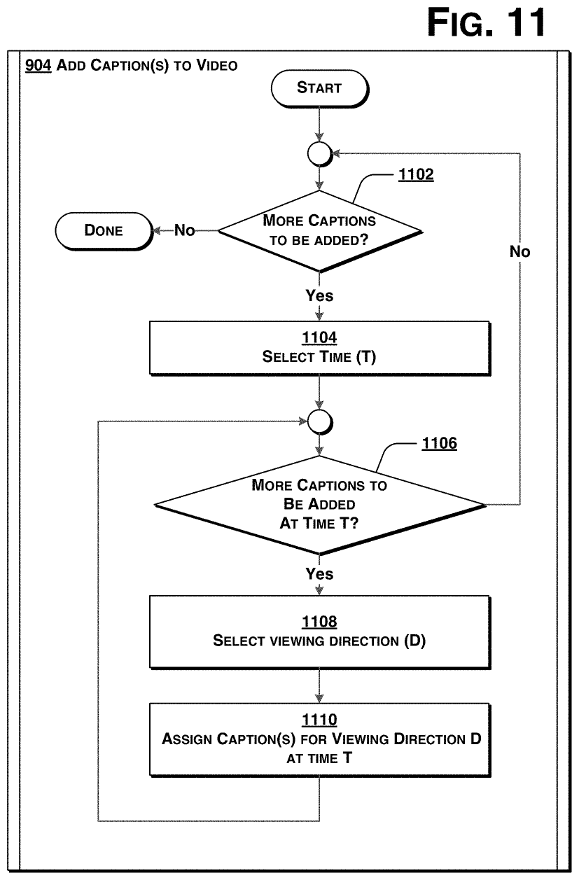

With reference to the flowchart in FIG. 9, video production 900 of a VR video (360-degree or otherwise) includes capturing and/or generating the video content (at 902) and then adding one or more captions to the video (at 904). In the case of real-time rendered video, the captions may be added at viewing time.

The video may be generated (at 902) using general-purpose and/or specialized computer systems and/or camera systems. The addition of captions to the video (at 904) is typically done in a post-production phase, and may use general-purpose and/or specialized computer systems, e.g., a computer system 1000 as shown in FIG. 10, including a processor 1002, display 1004, and memory 1006. A captioning application 1008 in memory 1006 supports the functionality of adding captions to the video (corresponding to 904 in FIG. 9). The captioning application 1008 preferably provides a graphical user interface (GUI) (e.g., on the display 1004) that supports viewing of the video content and addition of captions to the video content. The captioning application 1008 on computer system 1000 may include a database 1010 for storing the video content and captioning information. The video data 1012 and caption data 1014 may be stored and accessed in the database 1010.

The caption data 1014 may include caption-rendering policies, including, e.g., policies relating to how captions should be rendered during transitions.

The computer system 1000 may include other components (not shown and discussed below in the section on computing).

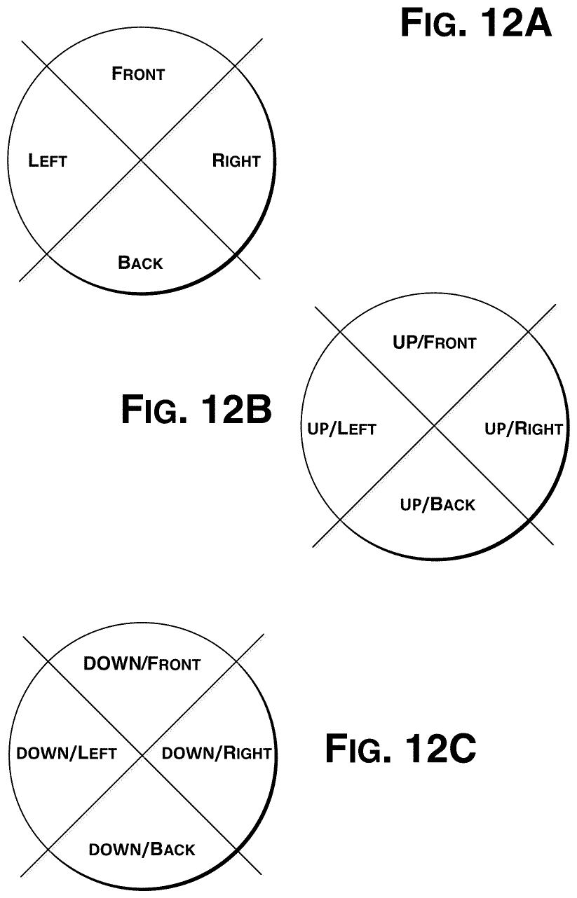

Functionality of an exemplary captioning application or mechanism 1008 for adding captions to the video (corresponding to 904 in FIG. 9) is described with respect to the flowchart in FIG. 11.

While there are more captions to be added (at 1102), a user (e.g., an editor) uses the computer display to select a portion of video to be captioned. The user selects the start time (T) of the portion of video to be captioned (at 1104).

While there are still captions to be added at the selected start time (T) (at 1106), the user selects a viewing direction (D) (at 1108) and assigns one or more captions to be viewed at time T and in viewing direction D (at 1110). The assignment of captions to a viewing direction (at 1110) includes setting at least the content to be rendered (e.g., the text, graphic, etc.) and a location of the content. Since the video is a VR (e.g., 360-degree) video, the location for each caption preferably includes a depth factor. The assignment of a caption may also include other information (e.g., a style for the content, etc.).

Captions may be inserted into the video using techniques such as described in U.S. Pat. No. 9,215,436, titled “Insertion of 3D objects in a stereoscopic image at relative depth,” issued Dec. 15, 2015, the entire contents of which are hereby fully incorporated herein by reference for all purposes. U.S. Pat. No. 9,215,436 describes techniques for rendering at least one object into a stereoscopic image for a display device.

Multiple captions may be added at different locations for a given time T. The captioning application 1008 preferably supports the easy repetition of one caption in multiple directions (e.g., using a cut-and-paste-type operation).

The captioning application 1008 preferably supports the easy setting of the duration for a caption (e.g., from time Ti to time Tj).

Once the user has added the captions for all directions for a given time (at 1106, 1108, 1110), the user may add captions at different times (1102, 1104, 1106, 1108, 1110) and/or for different viewing directions.

### Alternative Embodiments

Although the 3-D space is continuous in all directions, in some embodiments hereof, in order to facilitate placement of a caption in a 360-degree video, the 3-D space may be divided into a fixed number of regions or locations relative to the viewer. As will be appreciated, these regions essentially correspond to a fixed number of viewing directions. Preferably adjacent points of have some overlap.

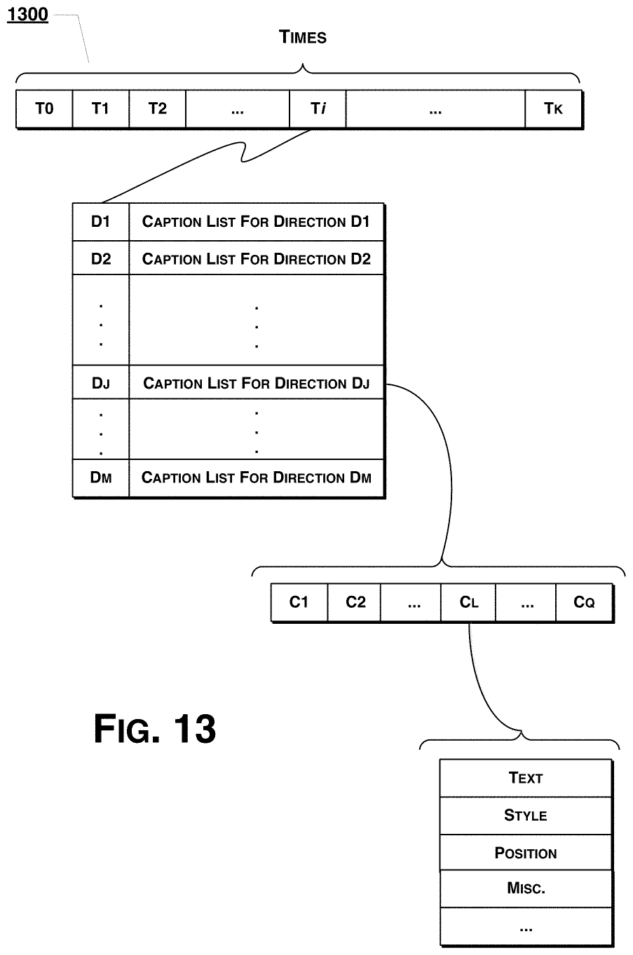

In one exemplary implementation, as shown in FIGS. 12A-12C, the 3-D space is divided into fourteen locations or points of: twelve (12) directional regions (front, left, right, back, up front, up left, up right, up back, down front, down left, down right, and down back) and top and bottom.

Although FIGS. 12A-12C show the virtual viewing space divided into essentially equal sized parts, in some implementations different sized regions may be used. For example, a particular implementation may have more and smaller sized partitions in the front, thereby providing greater caption placement granularity. Similarly, although twelve directional regions are shown in FIGS. 12A-12C, different numbers of partitions may be used and are contemplated herein. For example, a particular implementation may partition the viewing space into 24 directional regions.

A data structure such as the exemplary logical structure 1300 shown in FIG. 13 may be used to maintain and store caption information. At each time (from the start of the video at time T0 to the end of the video at time Tk, for some k) one or more captions may be associated with each directional region/location. The captions associated with different directional regions/locations may but need not be the same. Some directional regions/locations may have no caption at a given time. As shown in FIG. 13, each time Ti has an associated list of captions for each of the directions/regions. In the example shown in FIG. 13, there are M directions/regions. In the exemplary protocol shown in FIGS. 12A-12C, M=14 (corresponding to the twelve directional regions, and top and bottom directions).

A directional region/location may have zero or more captions associated therewith.

For each caption in a caption list, the data structure stores sufficient information to allow the caption to be rendered at the desired location in the video. This information may include one or more of:
The content to be rendered (e.g., the text, graphic, etc.);
The location of the content;
A style for the content.

The style for content may include font information, transparency information, size information, etc. A default style may be provided and/or set and the user (editor) may override the default per caption or for multiple (or even all) captions. Preferably the user can also override some of the style defaults, e.g., if they find certain fonts to be more readable than others.

The location is preferably a location in the 3D virtual space of the video being rendered, and preferably includes a depth component. Those of ordinary skill in the art will appreciate and understand, upon reading this description, that the editor will preferably place the caption at a comfortable depth in the image (e.g., at a depth at which the user is already supposed to focus). Preferably the caption is not positioned to block any major objects in the video.

In general, a scene may have one or more main objects on which the viewer will focus. The viewer does not typically focus on other objects in the scene, e.g., in the foreground or background. Preferably any caption in the scene, especially any caption associated with the main object, is positioned at substantially the same depth as the main object. This positioning of the object prevents the user having to shift focus within the image, thereby reducing eyestrain and fatigue. If there are multiple captions in a particular view, each caption is preferably positioned at an appropriate depth relative to other objects at that part of the view.

In the exemplary data structure shown in FIG. 13, at time Ti, the direction Dj has Q captions (denoted C₁, C₂, . . . , C_{Q}.

Those of ordinary skill in the art will appreciate and understand, upon reading this description, that the logical data structure shown in FIG. 13 is merely exemplary, and that different and/or other data structures may be used to store and maintain the captions associated with a 360-degree or VR video.

Rendering a VR Video with Captions

A VR video with associated caption information (e.g., generated as described above) may be rendered and viewed on viewing device, e.g., device 700 shown in FIG. 7. In the case of the alternate embodiment described above, the caption information (e.g., caption data 722) may be stored as described above with reference to FIG. 13), and determining the caption(s) for viewing direction D at time T may comprise looking up (at 810 in FIG. 8B) the caption list for direction D at time T (e.g., using the exemplary data structure 1300 of FIG. 13). The caption data 722 may include caption rendering policies, e.g., relating to how captions should be rendered during transitions. These policies may be global (with defaults) and specifiable or groups of captions or on a caption-by-caption basis.

### EXAMPLES

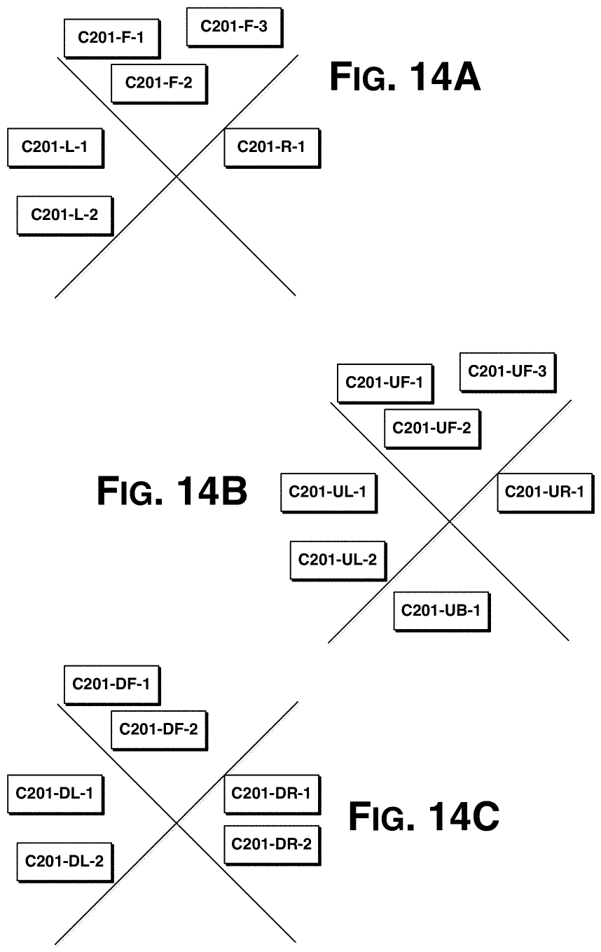

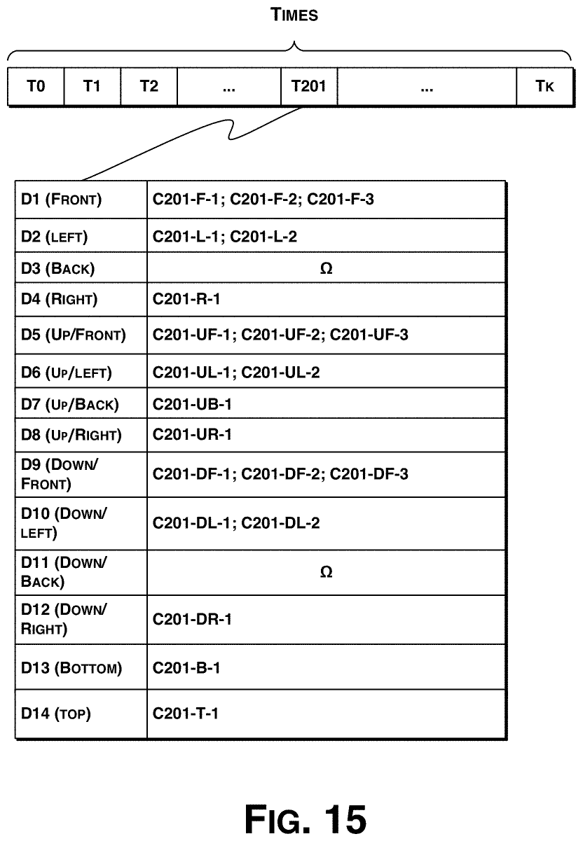

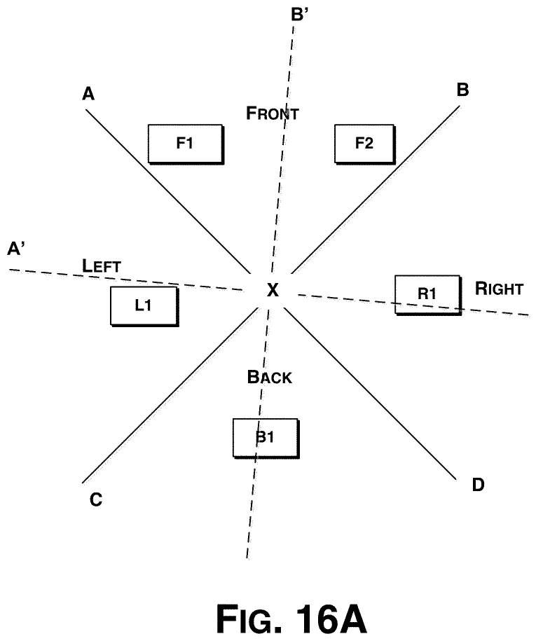

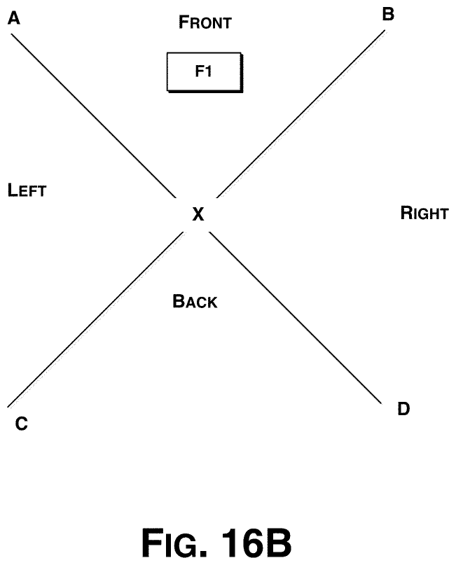

FIGS. 14A-14C and 15 show an example of captions created using the caption editing application (408, FIG. 4) at a time T₂₀₁ in a video. FIG. 14A shows the front, left, right, and back captions; FIG. 14B shows the up-front, up-left, up-right, and up-back captions; and FIG. 14C shows the down-front, down-left, down-right, and down-back captions. The top and bottom captions are shown in the data structure in FIG. 15, but not in the drawings in FIGS. 14A-14C. By convention herein, the symbol omega (Ω) is used to show an empty list (in FIG. 15). Thus, in this example, there is no back/rear caption (FIG. 14A) and no down-back caption (FIG. 14C).

In this example, as shown in FIG. 14A, the front has three captions (denoted C₂₀₁-F-1; C₂₀₁-F-2; and C₂₀₁-F-3), the left has two captions (denoted C₂₀₁-L-1; and C₂₀₁-L-2), and the right has one caption (denoted C₂₀₁-R-1).

During viewing (using the viewing/rendering application 708) on a viewing device 700, when the video data reaches time T₂₀₁, the application determines the user's viewing direction [D] (802 in FIG. 8A), determines the video images for viewing (804 in FIG. 8A), and determines the caption(s) for the viewing direction D (806 in FIG. 8A).

In this example, if the user is facing the front (in virtual space, as determined, e.g., using a gyroscope 712 in the viewing device 700), then the viewing device 700 will use (and render) the three captions denoted C₂₀₁-F-1; C₂₀₁-F-2; and C₂₀₁-F-3. If the user is facing the up-front direction, then the viewing device 700 will use (and render) the three (3) captions denoted (C₂₀₁-UF-1; C₂₀₁-UF-2; and C₂₀₁-UF-3). Similarly, if the user if viewing up (the top direction) at time T₂₀₁, then the viewing device will show the caption denoted C₂₀₁-T-1, and so on.

As should be appreciated, each of the captions may be or comprise any content (e.g., textual and/or graphical information) that may be rendered on the display of the viewing device 700. Each caption is preferably rendered in accordance with its settings (i.e., at the specified location in the 3D space, and using the specified style).

For example, and without loss of generality, the down/left caption C₂₀₁-DL-1 may be the text “Welcome home!” in a particular font, with a particular degree of transparency, and at a particular location in the down/left direction, whereas the caption C₂₀₁-UR-1 may be an image of a clown with a particular degree of transparency, and at a particular location in the up/right direction.

Transitions & Movement

As described above, while the user is viewing the video in the same direction, the caption(s) for that direction may be rendered. However, when the user changes their viewing direction the captions may change. For example, if a user is looking straight ahead (front direction) and moves slightly to the left, they may still be viewing the front direction (albeit the left side of the front). In such a situation the front-view caption(s) may continue to be rendered in their original place(s) or they may be allowed to drift.

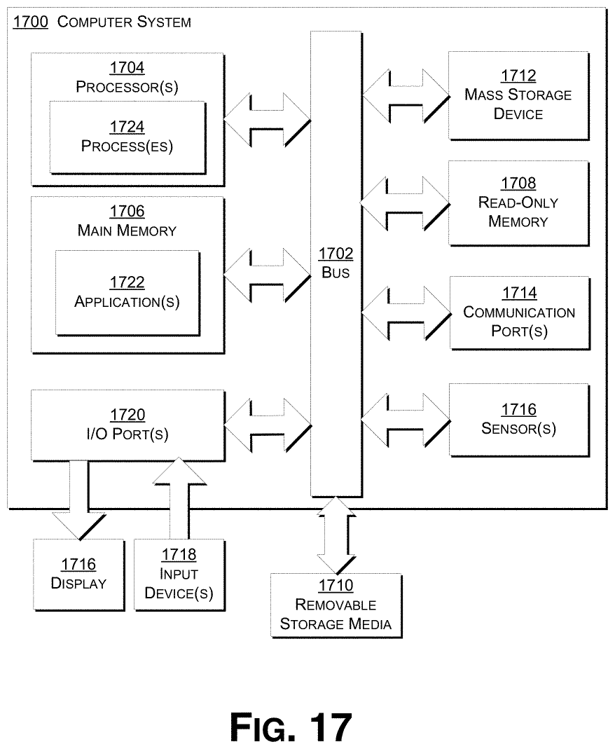

Consider the example in FIG. 16A where, at a first time shown, the user is at position X (in the 3D space) and looking (or facing directly to the front). The system assumes that the user has a view defined by AXB, and renders the front captions F1 and F2. For the sake of this example, assume that the captions are positioned in the drawing in their relative positions in the video, so that caption F1 is at the left side of the front view and caption F2 is at the far right side of the front view.

Suppose that the user then turns to the left, so that their view is defined by A′XB′. Now the caption F2 is out of view and should not be displayed.

In some cases, the position of a caption may default to the middle of the user's current view. Consider the caption F1 in FIG. 16B. If the user turns to look left or right or behind them, the caption F1 should still be displayed. In such cases the viewing application may allow the caption to drift or move with the viewer so that the caption remains centered in the user's viewing direction. Such caption drifting or movement may be undesirable, especially if the user is moving quickly.

Whether or not captions are permitted (or required) to drift may be an option set by the editor when the captions are created. For example, a system may default to no drifting captions, and allow a user (editor) to set captions to drift (e.g., using the miscellaneous field in the caption data structure 1300 shown in FIG. 13).

In some exemplary embodiments the movement of a caption may be based on the speed of the user's movement. For example, if a user is turning slowly to the left or right then a drifting caption may be acceptable, whereas if the user is moving rapidly to one side or another then the moving caption may be undesirable (as it may cause unwanted visual effects). The rate of the user's movement can be determined using, e.g., an accelerometer in the viewing device, and the amount of movement of a caption may be based on a threshold amount of movement (e.g., below the threshold the caption is allowed to drift, whereas at or above the threshold the caption is not rendered until the user's rotational movement slows).

While some default values have been suggested or provided those of ordinary skill in the art will appreciate and understand, upon reading this description, that different defaults may be used.

In some other exemplary embodiments, the captions for each scene may be created and then formed into a separate video stream that can run essentially in parallel with the video. The caption video stream requires much less bandwidth than the main video. In these embodiments the rendering process combines the main video with the caption video.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 17 is a schematic diagram of a computer system 1700 upon which embodiments of the present disclosure may be implemented and carried out.

According to the present example, the computer system 1700 includes a bus 1702 (i.e., interconnect), one or more processors 1704, a main memory 1706, read-only memory 1708, removable storage media 1710, mass storage 1712, and one or more communications ports 1714. Communication port(s) 1714 may be connected to one or more networks (not shown) by way of which the computer system 1700 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1704 can be any known processor, such as, but not limited to, an Intel® Itanium® or Itanium 2® processor(s), AMID® Opteron® or Athlon MP® processor(s), or Motorola® lines of processors, and the like. Communications port(s) 1714 can be any of an Ethernet port, a Gigabit port using copper or fiber, or a USB port, and the like. Communications port(s) 1714 may be chosen depending on a network such as a Local Area Network (LAN), a Wide Area Network (WAN), or any network to which the computer system 1700 connects. The computer system 1700 may be in communication with peripheral devices (e.g., display screen 1716, input device(s) 1718) via Input/Output (I/O) port 1720.

Main memory 1706 can be Random Access Memory (RAM), or any other dynamic storage device(s) commonly known in the art. Read-only memory (ROM) 1708 can be any static storage device(s) such as Programmable Read-Only Memory (PROM) chips for storing static information such as instructions for processor(s) 1704. Mass storage 1712 can be used to store information and instructions. For example, hard disk drives, an optical disc, an array of disks such as Redundant Array of Independent Disks (RAID), or any other mass storage devices may be used.

Bus 1702 communicatively couples processor(s) 1704 with the other memory, storage and communications blocks. Bus 1702 can be a PCI/PCI-X, SCSI, a Universal Serial Bus (USB) based system bus (or other) depending on the storage devices used, and the like. Removable storage media 1712 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 1706 is encoded with application(s) 1722 that support(s) the functionality as discussed herein (the application 1712 may be an application that provides some or all of the functionality of the services described herein, e.g., viewing/rendering application 708, FIG. 7 or captioning application 1008, FIG. 10). Application(s) 1722 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1704 accesses main memory 1706 via the use of bus 1702 in order to launch, run, execute, interpret or otherwise perform the logic instructions of the application(s) 1722. Execution of application(s) 1722 produces processing functionality of the service related to the application(s). In other words, the process(es) 1724 represent one or more portions of the application(s) 1722 performing within or upon the processor(s) 1704 in the computer system 1700.

For example, process(es) 1704 may include a captioning application process corresponding to captioning application 408 or a viewing/rendering application process corresponding to viewing/rendering application 708.

It should be noted that, in addition to the process(es) 1724 that carries(carry) out operations as discussed herein, other embodiments herein include the application 1722 itself (i.e., the un-executed or non-performing logic instructions and/or data). The application 1722 may be stored on a computer readable medium (e.g., a repository) such as a disk or in an optical medium. According to other embodiments, the application 1722 can also be stored in a memory type system such as in firmware, read only memory (ROM), or, as in this example, as executable code within the main memory 1706 (e.g., within Random Access Memory or RAM). For example, application(s) 1722 may also be stored in removable storage media 1710, read-only memory 1708, and/or mass storage device 1712.

Those skilled in the art will understand that the computer system 1700 can include other processes and/or software and hardware components, such as an operating system that controls allocation and use of hardware resources. For example, as shown in FIG. 6, the computer system 1700 may include one or more sensors 1726 (see sensors 710 in FIG. 6).

As discussed herein, embodiments of the present invention include various steps or acts or operations. A variety of these steps or acts may be performed by hardware components or may be embodied in machine-executable instructions, which may be used to cause a general-purpose or special-purpose processor programmed with the instructions to perform the operations. Alternatively, the steps or acts may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., an act is performed by or with the assistance of a human).

As noted above, as used herein, the term virtual reality (VR) generally encompasses content that may be at least partially artificial (e.g., computer generated), including AR.

Real Time

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system is not limited by this term or by how much time is actually taken. In some cases, real-time computation may refer to an online computation, i.e., a computation that produces its answer(s) as data arrive, and generally keeps up with continuously arriving data. The term “online” computation is compared to an “offline” or “batch” computation.

### CONCLUSIONS

As used herein, including in the claims, the phrase “at least some” means “one or more,” and includes the case of only one. Thus, e.g., the phrase “at least some ABCs” means “one or more ABCs”, and includes the case of only one ABC.

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed:

1. A method of adding caption information to a multi-view three-dimensional video, wherein the video has a duration, and wherein, at a given time in the duration of the video, a user may view multiple distinct scenes of the video, the method comprising:
(A) associating multiple distinct viewing directions or regions with the multi-view three-dimensional video;
(B) at a particular time in the duration of the video, associating one or more first captions with a first direction or region of said multiple distinct viewing directions or regions, and associating one or more second captions with a second direction or region of said multiple distinct viewing directions or regions, said first direction or region being distinct from said second direction or region.

2. The method of claim 1 further comprising:
repeating act (B) for multiple distinct particular times.

3. The method of claim 1, wherein said associating in (A) associates at least 12 multiple distinct viewing directions or regions with the video.

4. The method of claim 1, wherein the multiple distinct viewing regions are non-overlapping.

5. The method of claim 1 wherein said associating in (B) associates multiple captions with said video, the method further comprising:
(C) forming a second video from said multiple captions.

6. The method of claim 5 wherein said second video has a lower resolution than said multi-view three-dimensional video.

7. The method of claim 1, wherein at least one of said captions associated with said multi-view three-dimensional video is positioned at a depth location within said video.

8. A method comprising:
(A) displaying a multi-view three-dimensional video to a user, wherein scenes from the video are displayed to the user based on the direction the user is viewing, and wherein at least one particular time in the video has multiple captions associated with the video at the particular time; and
(B) at said at least one particular time in said video, displaying at least one caption to the user, wherein the at least one caption of said multiple captions is displayed to the user based on the direction the user is viewing at the particular time.

9. The method of claim 8 wherein the at least one caption is displayed in real time to the user.

10. The method of claim 8, wherein, in response to the user changing their viewing orientation, displaying a second at least one caption to the user.

11. The method of claim 8, wherein, in response to the user changing their viewing orientation, displaying said least one caption to the user based on the speed at which the user changes their viewing orientation.

12. A method comprising:
(A) obtaining a first video comprising a multi-view three-dimensional video;
(B) obtaining a second video comprising multi-view three-dimensional captions associated with said first video; and
(C) rendering said first video in combination with said second video.

13. An article of manufacture comprising a computer-readable medium having program instructions stored thereon, the program instructions, operable on a computer system, wherein execution of the program instructions by one or more processors of said computer system causes the one or more processors to carry out the acts of:
(A) associating multiple distinct viewing directions or regions with the multi-view three-dimensional video;
(B) at a particular time in the duration of the video, associating one or more first captions with a first direction or region of said multiple distinct viewing directions or regions, and associating one or more second captions with a second direction or region of said multiple distinct viewing directions or regions, said first direction or region being distinct from said second direction or region.

14. The article of manufacture of claim 13 wherein execution of the program instructions by one or more processors of said computer system causes the one or more processors to carry out the acts of:
repeating act (B) for multiple distinct particular times.

15. The article of manufacture of claim 13, wherein said associating in (A) associates at least 12 multiple distinct viewing directions or regions with the video.

16. The article of manufacture of claim 13, wherein the multiple distinct viewing regions are non-overlapping.

17. The article of manufacture of claim 13 wherein said associating in (B) associates multiple captions with said video, the acts further comprising:
(C) forming a second video from said multiple captions.

18. The article of manufacture of claim 17 wherein said second video has a lower resolution than said multi-view three-dimensional video.

19. The article of manufacture of claim 13, wherein at least one of said captions associated with said multi-view three-dimensional video is positioned at a depth location within said video.

20. A device constructed and adapted to perform the method of claim 1.
